(19) United States
(12) Patent Application Publication
(10) Pub. No.: US 2024/0241783 A1
(43) Pub. Date: Jul. 18, 2024

(54) SERVICE MONITORING METHOD AND APPARATUS FOR FLIGHT QUERY SYSTEM, DEVICE, AND STORAGE MEDIUM

(71) Applicant: TravelSky Technology Limited, Beijing (CN)

(72) Inventors: Junxiu Ran, Beijing (CN); Zizhan Zhou, Beijing (CN); Jiaoyang Zhan, Beijing (CN); Xu Zhang, Beijing (CN); Xiaoran He, Beijing (CN)

(73) Assignee: TravelSky Technology Limited, Beijing (CN)

(21) Appl. No.: 18/561,703

(22) PCT Filed: Apr. 21, 2022
(86) PCT No.: PCT/CN2022/088133

§ 371 Date: Nov. 16, 2023

(30) Foreign Application Priority Data
Jun. 30, 2021 (CN) 202110738853.5

(51) Int. Cl. G06F 11/07; G06F 11/34; G06F 16/242

(52) U.S. Cl. CPC G06F 11/0793; G06F 11/3457; G06F 16/242

(57) ABSTRACT

A service monitoring method and apparatus for a flight query system, a device, and a storage medium, including: on the basis of configuration information, generating at least one query command, the query command indicating a popular city pair corresponding to an item of identity information of an airline; respectively generating a query packet of each query command; sending the query packets to a flight query system, and simulating an operation of identity information of an airline requesting the flight query system to query a popular city pair to obtain a query result returned by the flight query system; and using a query result of target identity information of a target airline for each popular city pair to determine a shielding result of the target identity information of the target airline by the flight query system.

This application claims the priority to Chinese Patent Application No. 202110738853.5 titled “SERVICE MONITORING METHOD AND APPARATUS FOR FLIGHT QUERY SYSTEM, DEVICE, AND STORAGE MEDIUM”, filed with the China National Intellectual Property Administration on Jun. 30, 2021, which is incorporated herein by reference in its entirety.

### TECHNICAL FIELD

The present disclosure relates to the field of monitoring technology, and in particular to a service monitoring method and apparatus for a flight query system, a device, and a storage medium.

### BACKGROUND

Airlines usually adopts a POS (Point of Sale) system to set a POS rule for a flight query system, so that the flight query system controls and restricts flight queries through different channels or by different agents based on the POS rule. Incorrect or ineffective POS rule settings may cause a large number of errors to be reported by the flight query system, resulting in a significant impact on the airline's revenue. Therefore, it is very important to accurately monitoring of the flight query system.

According to the conventional monitoring technology, the service monitoring for the flight query system is performed based on statistics of log keywords in operation logs of the flight query system and configurations of baselines for the log keywords. The conventional monitoring technology relies on the operation logs generated by the flight query system, having poor real-time monitoring performance. Further, it is required to filter and count log information in the operation logs, further affecting the real-time monitoring performance in a case that there is a large amount of log information. Furthermore, in a case that there is less log information in the operation logs, misreported log information seriously affects monitoring results, resulting in a low monitoring accuracy and a high misreporting rate.

### SUMMARY

In view of this, in order to solve the above problems, a service monitoring method and apparatus for a flight query system, a device, and a storage medium are provided according to the present disclosure, improving the real-time performance and accuracy of service monitoring for the flight query system and reducing the misreporting rate of the service monitoring for the flight query system. Following technical solutions are provided.

A service monitoring method for a flight query system is provided. The service monitoring method includes: generating one or more query instructions based on preconfigured configuration information, where the configuration information indicates an airline, one or more pieces of identity information of the airline, and at least one popular city pair corresponding to each piece of the identity information, and the query instruction indicates a popular city pair corresponding to a piece of identity information of the airline; generating a query message for each of the query instructions based on a preconfigured query message template; sending the query message to the flight query system, simulating a piece of identity information of the airline to request the flight query system to query a popular city pair, and obtaining a query result from the flight query system; and determining a blocking result of the flight query system on target identity information of a target airline based on a query result of a popular city pair queried by using the target identity information of the target airline.

A service monitoring apparatus for a fight query system is provided. The service monitoring apparatus includes: a query instruction generation unit, a query message generation unit, a simulation query unit, and a blocking result determination unit. The query instruction generation unit is configured to generate one or more query instructions based on preconfigured configuration information, where the configuration information indicates an airline, one or more pieces of identity information of the airline, and at least one popular city pair corresponding to each piece of the identity information, and the query instruction indicates a popular city pair corresponding to a piece of identity information of the airline. The query message generation unit is configured to generate a query message for each of the query instructions based on a preconfigured query message template. The simulation query unit is configured to send the query message to the flight query system, simulate a piece of identity information of the airline to request the flight query system to query a popular city pair, and obtain a query result from the flight query system. The blocking result determination unit is configured to determine a blocking result of the flight query system on target identity information of a target airline based on a query result of a popular city pair queried by using the target identity information of the target airline.

A computer device is provided. The computer device includes a processor and a memory. The processor and the memory are connected through a communication bus. The processor is configured to call and execute a program stored in the memory. The memory stores the program which is executed to perform the service monitoring method for a flight query system.

A computer-readable storage medium is provided. The computer-readable storage medium stores a computer executable instruction. The computer executable instruction is executed to perform the service monitoring method for a flight query system.

A service monitoring method for a flight query system, a service monitoring apparatus for a flight query system, a device, and a storage medium are provided according to the present disclosure. With the method, the target identity information of the target airline is simulated to request the flight query system to query a popular city pair, and a blocking result of the flight query system on the target identity information of the target airline is determined, facilitating the service monitoring personnel of the flight query system determining the operation of the flight query system based on a blocking result of the flight query system on identity information of each of airlines.

According to present disclosure, the target identity information of the target airline is simulated to request the flight query system to query a popular city pair, thereby performing service monitoring on the flight query system. With the service monitoring method according to the present disclosure, service monitoring can be performed on the flight query system before operating externally without relying on the operation logs of the flight query system, effectively improving the real-time performance of the service monitoring on the flight query system. Moreover, the service monitoring method according to the present disclosure is not limited to the amount of operation information generated by the flight query system operating externally at different time instants, thereby further improving the accuracy of service monitoring for the flight query system and reducing the misreporting rate of service monitoring for the flight query system.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. Apparently, the drawings in the following description show only some embodiments of the present disclosure, and other drawings may be obtained by those skilled in the art from the drawings without any creative work. In addition, the present disclosure may be further applied to other similar scenarios based on the drawings. The same reference numerals in the drawings represent the same structure or operation unless it is obvious from the language environment or otherwise stated.

FIG. 1 is a flowchart of a service monitoring method for a flight query system according to an embodiment of the present disclosure;

FIG. 2 is a flowchart of determining a blocking result of a flight query system on target identity information of a target airline based on a query result of a popular city pair queried by using the target identity information of the target airline according to an embodiment of the present disclosure;

FIG. 3 is a flowchart of determining whether a query result indicates a query failure according to an embodiment of the present disclosure;

FIG. 4 is a schematic diagram of a service monitoring method for a flight query system according to an embodiment of the present disclosure;

FIG. 5 is a schematic diagram of a service monitoring method for a flight query system according to an embodiment of the present disclosure;

FIG. 6 is an exemplary diagram of a service monitoring method for a flight query system according to an embodiment of the present disclosure;

FIG. 7 is an exemplary diagram of a service monitoring method for a flight query system according to another embodiment of the present disclosure;

FIG. 8 is a schematic structural diagram of a service monitoring apparatus for a flight query system according to an embodiment of the present disclosure; and

FIG. 9 is a block diagram showing a hardware structure of a computer device to which a service monitoring method for a flight query system is applied according to an embodiment of the present disclosure.

### DETAILED DESCRIPTION OF THE EMBODIMENTS

Hereinafter, the embodiments of the present disclosure are described in detail with reference to the drawings. Although some embodiments of the present disclosure are shown in the drawings, it should be understood that the present disclosure may be implemented in various forms and should not be limited to the embodiments described herein. The embodiments are provided for thoroughly and completely understanding the present disclosure. It should be understood that the drawings and the embodiments in the present disclosure are only schematic, and are not intended to limit the protection scope of the present disclosure.

The term “including” and variations thereof in the present disclosure means open-ended inclusion, that is, “including but not limited to”. The term “based on” means “at least partially based on”. The term “one embodiment” means “at least one embodiment”. The term “another embodiment” means “at least one another embodiment”. The term “some embodiments” means “at least some embodiments”. The definitions of other terms are provided in the following descriptions.

It should be noted that the concepts such as “first” and “second” mentioned in the present disclosure are used to distinguish different devices, modules or units, and are not intended to limit an order or interdependence of functions performed by the devices, modules or units.

It should be noted that the modifications such as “one” and “multiple” mentioned in the present disclosure are illustrative and not restrictive. Those skilled in the art should understand that the modifications should be understood as “one or more” unless otherwise expressly indicated in the context.

In order to maximize revenue, airlines adopt a POS (Point of Sale) system to set a POS rule to control and restrict channels and agents. Incorrect or ineffective POS rule settings may cause a large number of errors to be reported by the flight query system, resulting in a significant impact on the airline's revenue. Therefore, it is very important to accurately monitoring of the flight query system. However, the conventional monitoring technology is performed based on statistics and baselines of log keywords, having a low accuracy, a high misreporting rate and a poor real-time performance. Therefore, an accurate and efficient service monitoring method for a flight query system is required to ensure the correct operation of the flight query system and ensure the maximum interests of airlines.

Due to the low possibility of airlines imposing sales restrictions on popular city pairs and the limited number of popular city pairs, the service monitoring method for a flight query system according to the present disclosure may be a service monitoring method for a flight query system based on a popular city pair and an important identity. Without executing a large number of instructions to perform statistics on results to obtain a blocking result, a popular city pair is accurately queried with an important identity and a query result is acquired, thereby monitoring the flight query system. Thus, the impact of invalid returns on the blocking result can be effectively reduced, the time period for performing the monitoring process can be reduced and the real-time performance is improved, the monitoring process is lightened, the performance consumption of service monitoring on a server is reduced, and the accuracy and efficiency of the monitoring process is improved.

In order to facilitate the understanding of a service monitoring method for a flight query system according to the present disclosure, the following technical terms involved in the flight query system are explained firstly.

A POS system, known as Point Of Sales, is a system used by an airline to control and restrict channels and agents.

A popular city pair is represented by three character codes for popular departure and destination cities.

An important identity is an important office number of an airline.

TAM represents an application monitoring system.

AVE/AV represents a flight state query system.

A service monitoring method for a flight query system based on a popular city pair and an important identity is provided according to the present disclosure. Based on an office number of an important identity, a flight state of an airline corresponding to a predetermined popular city pair is queried. Then, a result is analyzed and an operation state of the flight query system is monitored, so that it is determined whether a POS rule is correct and effective, thereby maximizing the interests of the airline.

In order to make the above objectives, features, and advantages of the present disclosure apparent and understandable, the present disclosure is described in detail in conjunction with the drawings and the specific embodiments.

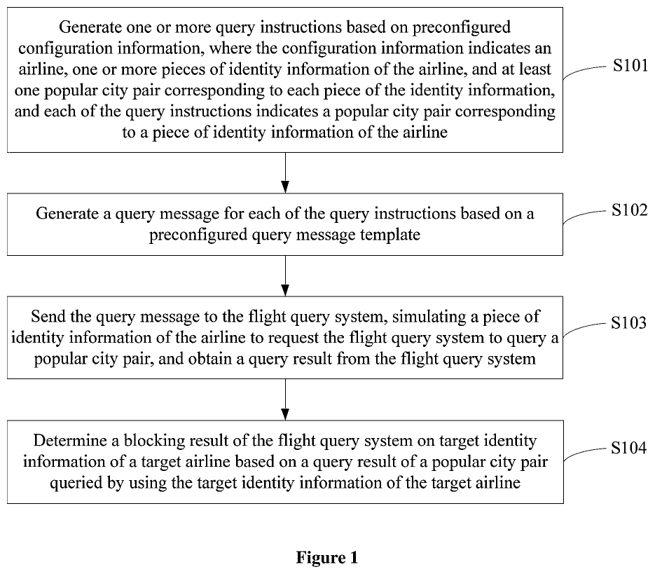

Hereafter, a service monitoring method for a flight query system according to an embodiment of the present disclosure is described in detail in conjunction with a flowchart of a service monitoring method for a flight query system shown in FIG. 1. As shown in FIG. 1, the service monitoring method for a flight query system includes the following steps S101 to S104.

In S101, one or more query instructions are generated based on preconfigured configuration information. The configuration information indicates an airline, one or more pieces of identity information of the airline, and at least one popular city pair corresponding to each piece of the identity information. Each of the query instructions indicates a popular city pair corresponding to a piece of identity information of the airline.

Exemplary, the configuration information is preconfigured. The configuration information indicates an airline, one or more pieces of identity information of the airline, and at least one popular city pair corresponding to each piece of the identity information. Thus, one or more query instructions may be generated based on the configuration information. Taking one query instruction as an example, the query instruction indicates a popular city pair corresponding to a piece of identity information of the airline.

In an embodiment of the present disclosure, the one or more query instructions are generated based on the preconfigured configuration information by: determining an airline indicated by the preconfigured configuration information; acquiring one or more pieces of identity information of the airline; and for each piece of identity information of the airline, determining a channel corresponding to the identity information and one or more popular city pairs corresponding to the identity information, and generating, for each of the popular city pairs, a query instruction based on the identity information of the airline, the channel corresponding to the identity information, and the popular city pair.

Exemplary, the identity information may be an important identity.

For example, a channel MCSS is preconfigured for BJS191, a channel IBE is preconfigured for SHA717, and the configuration information is configured as follows: the airline is CA, an important identity set is [SHA717, BJS191], and a popular city pair set corresponding to each of important identities in the important identity set is [PEKSHA, PEKCAN].

The one or more query instructions generated based on the configuration information include: a query instruction 1, a query instruction 2, a query instruction 3, and a query instruction 4. The query instruction 1 indicates CA, SHA717, PEKSHA, and IBE. The query instruction 2 indicates CA, SHA717, PEKCAN, and IBE. The query instruction 3 indicates CA. BJS191, PEKSHA, and MCSS. The query instruction 4 indicates CA, BJS191, PEKCAN, and MCSS.

In S102, a query message for each of the query instructions is generated based on a preconfigured query message template.

In an embodiment of the present disclosure, the query message for each of the query instructions is generated based on the preconfigured query message template by: determining a channel indicated by the query instruction; querying a predetermined correspondence relationship between channels and query message templates to acquire a query message template corresponding to the determined channel; and filling the airline, the identity information, the channel, and the popular city pair indicated by the query instruction at corresponding positions in the acquired query message template to generate the query message for the query instruction.

Exemplary, different channels correspond to different query message templates. In each of the query message templates, filling positions for an airline, identity information, a channel and a popular city pair are preset.

In S103, the query message is sent to the flight query system, a piece of identity information of the airline is simulated to request the flight query system to query a popular city pair, and a query result is obtained from the flight query system.

In an embodiment of the present disclosure, the query message may be sent to the flight query system, a piece of identity information of the airline is simulated to request the flight query system to query a popular city pair, and a query result is obtained from the flight query system. Exemplary, in a case that the query message indicates an airline 1, identity information 1 and a popular city pair 1, the query message is to the flight query system, identity information 1 of the airline 1 may be simulated to request the flight query system to query the popular city pair 1, and a query result is obtained from the flight query system

Exemplary, the query result may be referred to as a return of the query message.

In S104, a blocking result of the flight query system on target identity information of a target airline is determined based on a query result of a popular city pair queried by using the target identity information of the target airline.

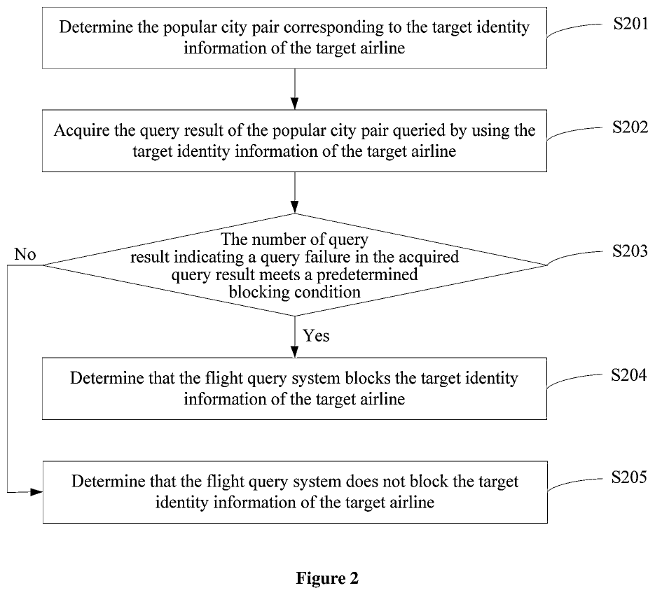

According to an embodiment of the present disclosure, the blocking result of the flight query system on the target identity information of the target airline is determined based on the query result of the popular city pair queried by using the target identity information of the target airline by performing the steps shown in FIG. 2. As shown in FIG. 2, the following steps S201 to S205 are performed.

In S201, the popular city pair corresponding to the target identity information of the target airline is determined.

In an embodiment of the present disclosure, each of airlines indicated by the configuration information is a target airline. For a target airline, each piece of identity information of the target airline indicated by the configuration information is a piece of target identity information of the target airline.

For each of the target airlines indicated by the configuration information, the blocking result determination process shown in FIG. 2 is performed based on each piece of target identity information of the target airline to obtain a blocking result of the flight query system on the target identity information of the target airline. Then, for each of the target airlines, service monitoring may be performed on the flight query system based on a blocking result of the flight query system on each piece of target identity information of the target airline.

In S202, the query result of the popular city pair queried by using the target identity information of the target airline is acquired.

Exemplary, taking one piece of target identity information of one target airline as an example, popular city pairs corresponding to the target identity information indicated by the configuration information may be determined. For each of individual popular city pairs, a query result, obtained by simulating the target identity information of the target airline to request the flight query system to query the popular city pair, is acquired from the flight query system. Thus, query results acquired for the determined individual popular city pairs may be considered as results by performing step S202.

In S203, it is determined whether the number of query result indicating a query failure in the acquired query result meets a predetermined blocking condition. In a case that the number of query result indicating a query failure in the acquired query result meets the predetermined blocking condition, proceed to step S204. In a case that the number of query result indicating a query failure in the acquired query result does not meet the predetermined blocking condition, proceed to step S205.

Exemplary, a query result indicates a query failure or a query success.

In an embodiment of the present disclosure, it is determined whether the number of query result indicating a query failure in the acquired query result meets the predetermined blocking condition by: determining the first number of the popular city pair corresponding to the target identity information of the target airline; calculating the second number of the query result indicating the query failure in the acquired query result; determining a proportion of the second number to the first number; determining whether the proportion exceeds a predetermined target proportion; determining the number of query result indicating the query failure in the acquired query result meets the predetermined blocking condition in a case that the proportion exceeds the target proportion; and determining the number of query result indicating the query failure in the acquired query result does not meet the predetermined blocking condition in a case that the proportion does not exceed the target proportion.

The above is only a preferred manner in which it is determined whether the number of query result indicating a query failure in the acquired query result meets the predetermined blocking condition according to the embodiment of the present disclosure. The manner in which it is determined whether the number of query result indicating a query failure in the acquired query result meets the predetermined blocking condition may be configured by those skilled in the art according requirements, and is not limited herein.

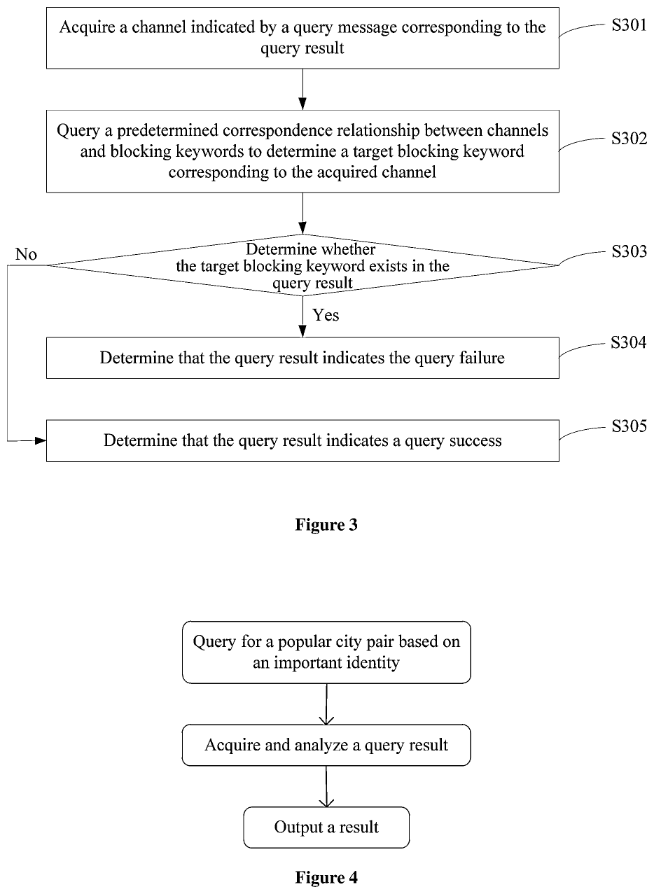

Further, in determining whether the number of query result indicating a query failure in the acquired query result meets the predetermined blocking condition, it is determined whether the query result indicates a query failure as shown in FIG. 3.

In S204, it is determined that the flight query system blocks the target identity information of the target airline.

Exemplary, in a case that the number of the query result indicating a query failure in the acquired query result obtained in step S202 meets the predetermined blocking condition, it is determined that the flight query system blocks the target identity information of the target airline.

In S205, it is determined that the flight query system does not block the target identity information of the target airline.

Exemplary, in a case that the number of the query result indicating a query failure in the acquired query result obtained in step S202 does not meet the predetermined blocking condition, it is determined that the flight query system does not block the target identity information of the target airline.

FIG. 3 is a flowchart of determining whether a query result indicates a query failure according to an embodiment of the present disclosure.

As shown in FIG. 3, the following steps S301 to S305 are performed.

In S301, a channel indicated by a query message corresponding to the query result is acquired.

Exemplary, a query message may be generated based on a query instruction. The query message is sent to the flight query system, a query result is obtained from the flight query system. In determining whether the query result indicates a query failure, a channel indicated by the query message may be acquired, and then a predetermined correspondence relationship between channels and blocking keywords is queried to determine a target blocking keyword corresponding to the acquired channel. For ease of differentiation, the determined blocking keyword may be referred to as a target blocking keyword. In a case that the target blocking keyword exists in the query result, it is determined that the query result indicates a query failure. In a case that the target blocking keyword does not exist in the query result, it is determined that the query result does not indicate a query failure. For that the query result does not indicate a query failure, it indicates that the query result indicates a query success.

In S302, a predetermined correspondence relationship between channels and blocking keywords is queried to determine a target blocking keyword corresponding to the acquired channel.

In S303, it is determined whether the target blocking keyword exists in the query result. In a case that the target blocking keyword exists in the query result, proceed to step S304. In a case that the target blocking keyword does not exist in the query result, proceed to step S305.

In S304, it is determined that the query result indicates a query failure.

In S305, it is determined that the query result indicates a query success.

The above is only a preferred manner in which it is determined whether a query result indicates a query failure according to the embodiment of the present disclosure. The manner in which it is determined whether a query result indicates a query failure may be configured by those skilled in the art according requirements, and is not limited herein.

A service monitoring method for a flight query system is provided according to the present disclosure. With the method, the target identity information of the target airline is simulated to request the flight query system to query a popular city pair, and a blocking result of the flight query system on the target identity information of the target airline is determined, facilitating the service monitoring personnel of the flight query system determining the operation of the flight query system based on a blocking result of the flight query system on identity information of each of airlines.

According to present disclosure, the target identity information of the target airline is simulated to request the flight query system to query a popular city pair, thereby performing service monitoring on the flight query system. With the service monitoring method according to the present disclosure, service monitoring can be performed on the flight query system before operating externally without relying on the operation logs of the flight query system, effectively improving the real-time performance of the service monitoring on the flight query system. Moreover, the service monitoring method according to the present disclosure is not limited to the amount of operation information generated by the flight query system operating externally at different time instants, thereby further improving the accuracy of service monitoring for the flight query system and reducing the misreporting rate of service monitoring for the flight query system.

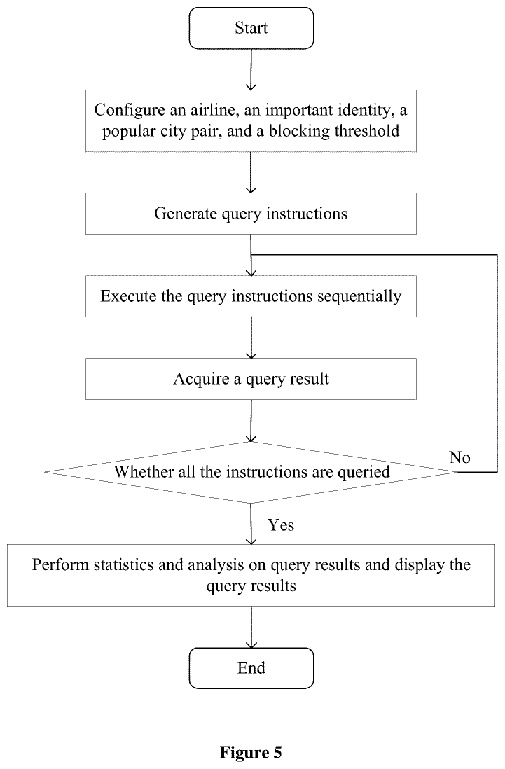

In order to facilitate the understanding of a service monitoring method for a flight query system according to the embodiments of the present disclosure, a detailed explanation is provided in conjunction with schematic diagrams of a service monitoring method for a flight query system as shown in FIGS. 4 to 5.

FIG. 4 is a schematic diagram of a service monitoring method for a flight query system according to an embodiment of the present disclosure.

As shown in FIG. 4, the service monitoring method for a flight query system includes: querying for a popular city pair based on an important identity; acquiring and analyzing a query result, and obtaining an effective state of a POS rule; outputting a result. A blocking result of the airline on the important identity to monitor the operation of the flight query system.

FIG. 5 is a schematic diagram of a service monitoring method for a flight query system according to an embodiment of the present disclosure. As shown in FIG. 5, a service monitoring method for a flight query system according to an embodiment of the present disclosure includes the following steps 1 to 6.

In step 1, an airline, an important identity, a popular city pair, and a blocking threshold are configured.

Exemplary, the blocking threshold may be considered as a target proportion.

In step 2, query instructions are generated. Specifically, query instructions are generated based on the configuration information in step 1.

In step 3, the query instructions generated in step 2 are executed sequentially. Specifically, for each of the query instructions, an AV message is generated and then is sent to an AV query cluster.

In step 4, a query result is acquired by acquiring a return of the query message in step 3 in a log.

In step 5, it is determined whether all the query instructions are executed. In a case that all the query instructions are executed, proceed to step 6. In a case that not all the query instructions are executed, proceed to step 3.

In step 6, statistics and analysis are performed on query results of all identities, and a result is displayed. Specifically, for each of airlines, a blocking state of each of important identities of the airline is outputted.

A service monitoring method for a flight query system is provided according to the embodiments of the present disclosure. A TAM simulates a real asynchronous message based on a configured popular city pair and an important identity, and sends a request to an AVE query cluster. The TAM acquires an execution result of each of query instructions by performing log collection. The TAM analyzes a collected log, including performing message management, service logic processing, and the like. The message management is performed to manage a current log and a query result. The service logic processing is performed to perform blocking keyword matching on a return and perform statistics and analysis to obtain a matching result. An output display component sets a display interface according to service requirements, acquires an analysis result from a database and display the analysis result in the display interface, thereby accurately displaying the operation of the system in the display interface. A self-developed page may be used for display or an open source front-end may be used.

Exemplary, an operation interface may be provided for service monitoring of a flight query system. In the operation interface, information, such as a configured important identity, an airline, a popular city pair, a blocking threshold, may be uploaded, and a blocking result may be displayed. A query instruction including an important identity, an airline and a popular city pair is acquired from a front-end interface, message is generated, and a request in a message format is sent to the AVE query cluster. The TAM acquires an execution result of each of query instructions by performing log collection. The TAM analyzes a collected log, including performing message management, service logic processing, and the like. The message management is performed to manage a current log and a query result. The service logic processing is performed to perform blocking keyword matching on a return and perform statistics and analysis to obtain a matching result.

A service monitoring method for a flight query system according to an embodiment of the present disclosure is described below in conjunction with a specific example. It should be noted that the example described herein is only an embodiment of the method according to the present disclosure and is not intend to limit the disclosure. The airline, the important identity, the popular city pair, and the blocking threshold in the present disclosure may be configured by technical personnel according to requirements. Examples are described in detail below.

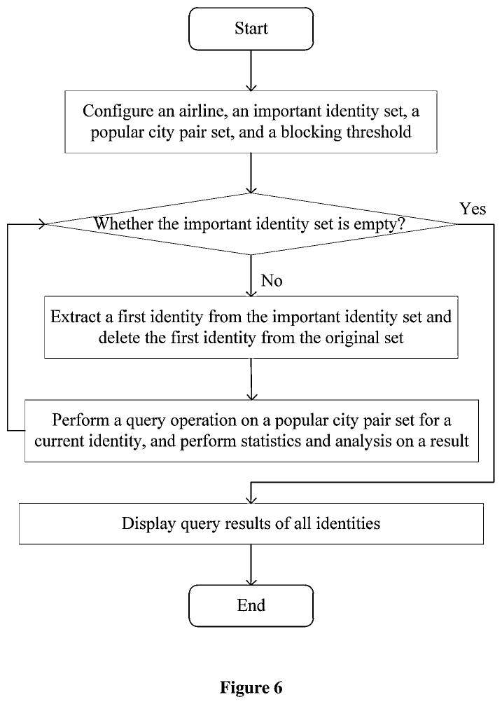

Example 1 is an embodiment of a service monitoring method for a flight query system, which is applicable to a case where similar popular city pairs are configured for an important identity. The process in example 1 is shown in FIG. 6.

In step 1, an airline CA is configured, an important identity set is configured as [PEK184, PEK222, PEK666, SHA777, CAN011, HAK969], and a popular city pair set is configured as [PEKSHA, PEKCAN, SHACAN], and a blocking threshold is configured as 0.2.

In step 2, it is determined whether the important identity set is empty. In a case that the important identity set is empty, proceed to step 5. In a case that the important identity set is not empty, proceed to step 3.

In step 3, a first identity PEK184 is extracted from the important identity set and is deleted from the original set. The important identity set is updated to [PEK222, PEK666, SHA777, CAN011, HAK969].

In step 4, a popular city pair set corresponding to a current identity is queried, and statistics and analysis is performed on a result, and then proceed to step 2.

In step 5, a query result corresponding to each of identities is displayed. Specifically, a blocking state of each of the identities is outputted.

The step 4 shown in FIG. 6 is performed as follows.

In step 4.1, the popular city pair set is configured as [PEKSHA, PEKCAN, SHACAN], the number of limited popular city pairs is initialized to 0, and the total number of popular city pairs is initialized to 3.

In step 4.2, it is determined whether the popular city pair set is empty. In a case that the popular city pair set is empty, proceed to step 4.7. In a case that the popular city pair set is not empty, proceed to step 4.2.

In step 4.3, a first city pair PEKSHA is extracted from the popular city pair set and is deleted from the original set. The popular city pair set is updated to [PEKCAN, SHACAN].

In step 4.4, a query instruction for the current popular city pair PEKSHA is executed with a current identity PEK184.

In step 4.5, a query result for the popular city pair is acquired. Specifically, a return of the query instruction is intercepted in a log.

In step 4.6, the return is matched with a blocking keyword. In a case that the return is matched with the blocking keyword, the current popular city pair is limited, and the number of the limited popular city pairs is increased by 1, and then proceed to step 4.2.

In step 4.7, a blocking proportion is calculated. Specifically, the blocking proportion is obtained by dividing the number of the limited popular city pairs by the total number of the popular city pairs. In a case that the blocking proportion is greater than or equal to the blocking threshold of 0.2, it is determined that the current identity is blocked. In a case that the blocking proportion is less than the blocking threshold of 0.2, it is determined that the current identity is not blocked.

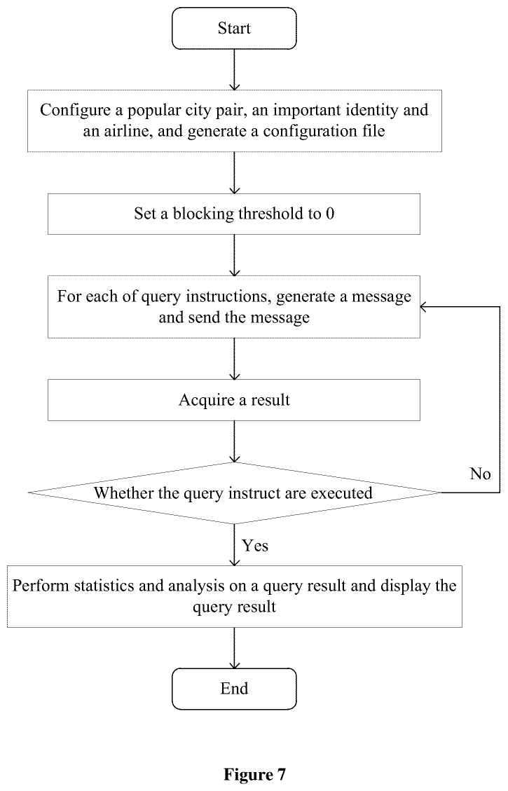

Example 2 is another embodiment of a service monitoring method for a flight query system, which is applicable to a case where different popular city pairs are configured. The process in example 2 is shown in FIG. 7.

In step 1, airlines CA and MU are configured, an important identity of CA is configured as BJS191, an important identity of MU is configured as SHA717, a popular city pair for BJS191 is configured as PEKSHA and SHAPEK, a popular city pair for SHA717 is configured as SHACAN and SHAPEK, and the following query instructions are generated:
PEKSHA, BJS191, CA, MCSS;
SHAPEK, BJS191, CA, MCSS;
SHACAN, SHA717, MU, IBE; and
SHAPEK, SHA717, MU, IBE.

In step 2, a blocking threshold is set to 0.

In step 3, for each of the query instructions, a message is generated and is sent. A message is generated based on a first line of query instruction in the configuration file as follows.

For example, taking the query instruction “PEKSHA, BJS191, CA, MCSS” as an example, the following query message is generated:

08.1/MCSS_AVE_TODE02/AVE_TODE2_C/1/1234567890/C/1E/E/123456/1/CN/0/RE S/0/*GAPP/0/0/BJS191////1E/123456/41/32,32/AV:HO/PEKSHA/+/CA/D

In step 4, a result is acquired. Specifically, a return is acquired in a log file, and the return is further processed to obtain a query result.

In step 5, it is determined whether all the instructions are queried. In a case that all the instructions are queried, proceed to step 6. In a case that not all the instructions are queried, proceed to step 3.

In step 6, a query result based on all the identities is displayed. For each of the airlines, a blocking state of each of identities of the airline is outputted.

In an embodiment of the present disclosure, taking a channel indicated by a query instruction being MCSS as an example, a blocking keyword corresponding to MCSS is matched with a query result of the query instruction. In a case that the blocking keyword corresponding to MCSS exists in the query result, the identity of the airline is blocked. In a case that the blocking keyword corresponding to MCSS does not exist in the query result, the identity of the airline is not blocked.

Exemplary, a blocking keyword corresponding to MCSS is “DS #”

The above is only the preferred content of the blocking keyword corresponding to MCSS according to the embodiment of the present disclosure. The specific content of the blocking keyword corresponding to MCSS may be set by those skilled in the art according to requirements, and is not limited herein.

A service monitoring method for a flight query system is provided according to the present disclosure. With the method, the target identity information of the target airline is simulated to request the flight query system to query a popular city pair, and a blocking result of the flight query system on the target identity information of the target airline is determined, facilitating the service monitoring personnel of the flight query system determining the operation of the flight query system based on a blocking result of the flight query system on identity information of each of airlines.

According to present disclosure, the target identity information of the target airline is simulated to request the flight query system to query a popular city pair, thereby performing service monitoring on the flight query system. With the service monitoring method according to the present disclosure, service monitoring can be performed on the flight query system before operating externally without relying on the operation logs of the flight query system, effectively improving the real-time performance of the service monitoring on the flight query system. Moreover, the service monitoring method according to the present disclosure is not limited to the amount of operation information generated by the flight query system operating externally at different time instants, thereby further improving the accuracy of service monitoring for the flight query system and reducing the misreporting rate of service monitoring for the flight query system.

The flow charts and block diagrams in the drawings illustrate possible system architectures, functions and operations that may be implemented by a system, a method, and a computer program product according to various embodiments of the present disclosure. Each block in the flow charts or the block diagrams may represent a part of a module, a program section or codes, and a part of the module, the program section or the codes includes one or more executable instructions for implementing specified logic functions. It should be noted that, in some alternative implementations, the functions marked in blocks may be performed in an order different from the order shown in the drawings. For example, two blocks shown in succession may actually be executed in parallel, or sometimes may be executed in a reverse order, which depends on the functions involved. It should also be noted that each of blocks in the block diagrams and/or flow charts and a combination of the blocks in the block diagrams and/or flow charts may be implemented by a dedicated hardware-based system that performs specified functions or actions, or may be implemented by a combination of dedicated hardware and computer instructions.

The names of messages or information exchanged between multiple apparatuses in the embodiments of the present disclosure are only for illustrative purposes, and are not intended to limit the scope of the messages or information.

It should be noted that although the above operations are described in a specific order, it should not be understood that these operations are required to be performed in the specific order or performed in a sequential order. Under certain circumstances, multitasking and parallel processing may be advantageous.

It should be understood that, steps described in the embodiments of the method of the present disclosure may be performed in different orders and/or performed in parallel. In addition, the embodiments of the method may include additional steps and/or the shown steps that may be omitted. The scope of the present disclosure is not limited thereto.

Computer program codes for performing the operations in the present disclosure may be written in one or more programming languages or combinations thereof. The programming languages include, but are not limited to, an object-oriented programming language, such as Java, Smalltalk, and C++, and a conventional procedural programming language, such as C language or a similar programming language. The program codes may be entirely executed on a user computer, partially on the user computer, as a standalone software package, partially on the user computer and partially on a remote computer, or entirely on the remote computer or a server. In the case of involving a remote computer, the remote computer may be connected to a user computer or an external computer through any kind of network including the local area network (LAN) or the wide area network (WAN) (for example, the remote computer may be connected to the user computer or the external computer through Internet connection by an Internet service provider).

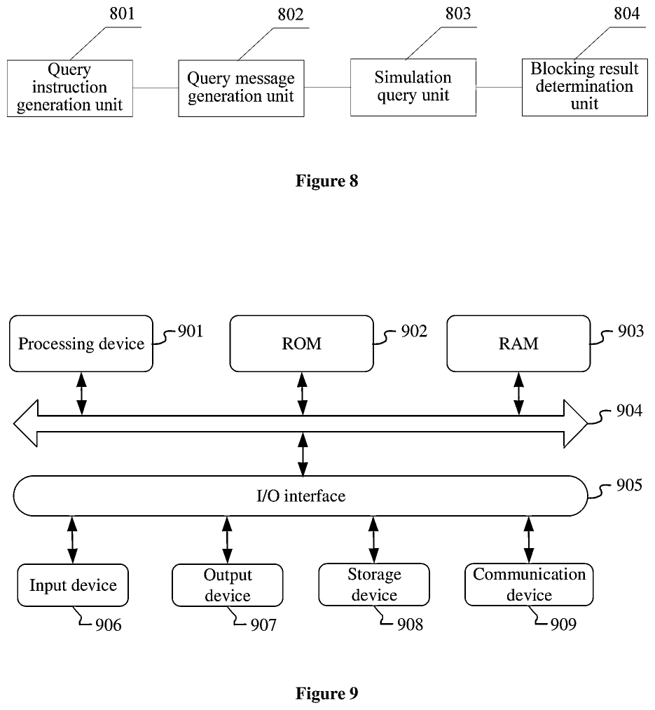

Based on the above commonalities, a service monitoring apparatus for a flight query system according to an embodiment of the present disclosure is described in detail as shown in FIG. 8.

As shown in FIG. 8, the apparatus includes: a query instruction generation unit 801, a query message generation unit 802, a simulation query unit 803, and a blocking result determination unit 804.

The query instruction generation unit 801 is configured to generate one or more query instructions based on preconfigured configuration information. The configuration information indicates an airline, one or more pieces of identity information of the airline, and at least one popular city pair corresponding to each piece of the identity information, and the query instruction indicates a popular city pair corresponding to a piece of identity information of the airline.

The query message generation unit 802 is configured to generate a query message for each of the query instructions based on a preconfigured query message template.

The simulation query unit 803 is configured to send the query message to the flight query system, simulate a piece of identity information of the airline to request the flight query system to query a popular city pair, and obtain a query result from the flight query system.

The blocking result determination unit 804 is configured to determine a blocking result of the flight query system on target identity information of a target airline based on a query result of a popular city pair queried by using the target identity information of the target airline.

According to an embodiment of the present disclosure, the query instruction generation unit includes: an airline determination unit, an identity information acquisition unit, and a query instruction generation subunit.

The airline determination unit is configured to determine an airline indicated by the preconfigured configuration information.

The identity information acquisition unit is configured to acquire one or more pieces of identity information of the airline.

The query instruction generation subunit is configured to: for each piece of identity information of the airline, determine a channel corresponding to the identity information and one or more popular city pairs corresponding to the identity information, and generate, for each of the popular city pairs, a query instruction based on the identity information of the airline, the channel corresponding to the identity information, and the popular city pair.

In an embodiment of the present disclosure, the query message generation unit includes a channel determination unit, a query message template acquisition unit, and a query message generation subunit.

The channel determination unit is configured to determine a channel indicated by the query instruction.

The query message template acquisition unit is configured to query a predetermined correspondence relationship between channels and query message templates to acquire a query message template corresponding to the determined channel.

The query message generation subunit is configured to fill the airline, the identity information, the channel, and the popular city pair indicated by the query instruction at corresponding positions in the acquired query message template to generate the query message for the query instruction.

In an embodiment of the present disclosure, the blocking result determination unit includes a popular city pair determination unit, a query result acquisition unit, a first judgment unit, a first determination unit, and a second determination unit.

The popular city pair determination unit is configured to determine the popular city pair corresponding to the target identity information of the target airline.

The query result acquisition unit is configured to acquire the query result of the popular city pair queried by using the target identity information of the target airline.

The first judgment unit is configured to determine whether the number of query result indicating a query failure in the acquired query result meets a predetermined blocking condition.

The first determination unit is configured to determine that the flight query system blocks the target identity information of the target airline in a case that the number of query result indicating a query failure in the acquired query result meets the predetermined blocking condition.

The second determination unit is configured to determine that the flight query system does not block the target identity information of the target airline in a case that the number of query result indicating a query failure in the acquired query result does not meet the predetermined blocking condition.

Furthermore, the service monitoring apparatus for a flight query system according to the embodiments of the present disclosure includes a second judgment unit. The second judgment unit is configured to determine whether a query result indicates a query failure. Specifically, the second judgment unit includes a channel acquisition unit, a block keyword determination unit, a second judgment subunit, a third determination unit, and a fourth determination unit.

The channel acquisition unit is configured to acquire a channel indicated by a query message corresponding to the query result.

The blocking keyword determination unit is configured to query a predetermined correspondence relationship between channels and blocking keywords to determine a target blocking keyword corresponding to the acquired channel.

The second judgment subunit is configured to determine whether the target blocking keyword exists in the query result.

The third determination unit is configured to determine that the query result indicates the query failure in a case that the target blocking keyword exists in the query result.

The fourth determination unit is configured to determine that the query result indicates a query success in a case that the target blocking keyword does not exist in the query result.

In an embodiment of the present disclosure, the first judgment unit includes: a first number determination unit, a second number calculation unit, a proportion determination unit, a second judgment subunit, a fifth determination unit, and a sixth determination unit.

The first number determination unit is configured to determine the first number of the popular city pair corresponding to the target identity information of the target airline.

The second number calculation unit is configured to calculate the second number of the query result indicating the query failure in the acquired query result.

The proportion determination unit is configured to determine a proportion of the second number to the first number.

The second judgment subunit is configured to determine whether the proportion exceeds a predetermined target proportion.

The fifth determination unit is configured to determine the number of query result indicating the query failure in the acquired query result meets the predetermined blocking condition in a case that the proportion exceeds the target proportion.

The sixth determining unit is configured to determine the number of query result indicating the query failure in the acquired query result does not meet the predetermined blocking condition in a case that the proportion does not exceed the target proportion.

The service monitoring apparatus for a flight query system according to the embodiments of the present disclosure may be implemented by using a TAM, which has a high integration and is easily and quickly implemented. Each of units in the service monitoring apparatus for a flight query system may be designed and implemented separately, and the units are connected through an interface to perform service monitoring.

The blocking result determination unit may be implemented by using scripts, such as python or java, in a background to obtain a query result and then analyze and process the query result.

Furthermore, the service monitoring apparatus for a flight query system according to the embodiments of the disclosure includes a display unit. The display unit may be configured to establish a webpage through a Django framework, acquire an analysis result, and then display the analysis result in a front-end page.

The units described in the embodiments of the present disclosure may be implemented by software or hardware. The names of the units do not limit the units in some cases. For example, the first acquisition unit may be described as “a unit for acquiring at least two internet protocol addresses”.

The functions described herein above may be performed, at least partially, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD) and the like.

A computer device is further provided according to an embodiment of the present disclosure. The computer device includes a processor and a memory. The processor and memory are connected through a communication bus. The processor is configured to call and execute a program stored in the memory. The memory is configured to store the program. The program is executed to perform the service monitoring method for a flight query system.

Reference is made to FIG. 9, which shows a schematic structural diagram of a computer device to which the embodiments of the present disclosure are applied. The computer device in the embodiments of the present disclosure may include, but not limited to, mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as a digital TV and a desktop computer. The computer device shown in FIG. 9 is exemplary, and is not intended to limit the functions and the usage scope of the embodiments of the present disclosure.

As shown in FIG. 9, the computer device 900 may include a processing device (such as a central processing unit and a graphic processor) 901. The processing device 901 may perform various appropriate actions and processing based on programs stored in a read-only memory (ROM) 902 or programs uploaded from a storage device 906 to a random access memory (RAM) 903. The RAM 903 further stores various programs and data required by the computer device 900 for operation. The processing device 901, the ROM 902, and the RAM 903 are connected to each other through a bus 904. An input/output (I/O) interface 905 is connected to the bus 904.

Generally, the following devices may be connected to the I/O interface 905: an input device 906 such as a touch screen, a touchpad, a keyboard, a mouse, a camera, a microphone, an accelerometer and a gyroscope; an output device 907 such as a liquid crystal display (LCD), a speaker, and a vibrator; a storage device 908 such as a magnetic tape and a hard disk; and a communication device 909. The communication device 909 may allow the computer device 900 to perform wireless communication or wired communication with other devices to exchange data. Although FIG. 9 shows a computer device 900 arranged with various devices, it should be understood that not all of the illustrated devices are implemented or included. Alternatively, more or fewer devices may be implemented or included.

According to an embodiment of the present disclosure, the process described with reference to the flow charts may be implemented as a computer software program. For example, a computer program product is further provided according to an embodiment in the present disclosure. The computer program product includes a computer program carried on a non-transitory computer readable medium. The computer program includes program codes for performing the method as shown in the flow chart. In the embodiment, the computer program may be downloaded from a network via the communication device 909 and then is installed, or is installed from the storage device 908, or is installed from the ROM 902. The computer program, when executed by the processing device 901, causes the processing device 901 to perform the functions defined in the method according to the embodiments of the present disclosure.

Furthermore, a computer-readable storage medium is provided according to an embodiment of the present disclosure. The computer-readable storage medium stores computer executable instructions. The computer executable instructions are executed to perform the service monitoring method for a flight query system described above.

The computer-readable medium carries one or more programs. The one or more programs, when executed by the computer device, cause the computer device to: generate one or more query instructions based on preconfigured configuration information, where the configuration information indicates an airline, one or more pieces of identity information of the airline, and at least one popular city pair corresponding to each piece of the identity information, and each of the query instructions indicates a popular city pair corresponding to a piece of identity information of the airline; generate a query message for each of the query instructions based on a preconfigured query message template; send the query message to the flight query system, simulate a piece of identity information of the airline to request the flight query system to query a popular city pair, and obtain a query result from the flight query system; and determine a blocking result of the flight query system on target identity information of a target airline based on a query result of a popular city pair queried by using the target identity information of the target airline.

In the context of the present disclosure, a machine-readable medium may be a tangible medium that may include or store a program that is used by or used in combination with an instruction execution system, apparatus or device. The machine-readable medium may be a machine-readable signal medium or a machine-readable storage medium. The machine-readable medium may include, but is not limited to, a system, an apparatus or a device in an electronic, magnetic, optical, electromagnetic, infrared, or semi-conductive form, or any combination thereof. Concrete examples of the machine-readable storage medium may include, an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device or any suitable combination thereof.

It should be noted that, the computer-readable medium in the present disclosure may be a computer-readable signal medium or a computer-readable storage medium or any combination thereof. The computer-readable storage medium may include, but is not limited to, a system, an apparatus, or a device in an electronic, magnetic, optical, electromagnetic, infrared, or semi-conductive form, or any combination thereof. Concrete examples of the computer-readable storage medium may include, but is not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device or any suitable combination thereof. In the present disclosure, the computer-readable storage medium may be any tangible medium including or storing a program, and the program may be used by or used in combination with an instruction execution system, apparatus, or device. In the present disclosure, the computer-readable signal medium may include a data signal in a baseband or transmitted as a part of a carrier wave and carrying computer-readable program codes. The transmitted data signal may be in various forms, including but not limited to an electromagnetic signal, an optical signal or any proper combination thereof. The computer-readable signal medium may alternatively be any computer-readable medium other than the computer-readable storage medium. The computer-readable signal medium may send, propagate or transmit a program that is used by or used in combination with an instruction execution system, apparatus or a component. The program codes stored in the computer-readable medium may be transmitted via any proper medium including but not limited to: a wire, an optical cable, radio frequency (RF) and the like, or any proper combination thereof.

The computer-readable medium may be included in the electronic device, or may exist independently without being assembled into the electronic device.

With the service monitoring method and apparatus for a flight query system, the device, and the storage medium according to the embodiments of the present disclosure, the efficiency of service monitoring for the flight query system is improved, the performance consumption of service monitoring for the flight query system on a server is reduced, effectively reducing the interference of invalid returns on determining the blocking result, and thereby effectively performing real-time service monitoring for the flight query system.

Although the subject matter is described in language specific to structural features and/or logical actions of the method, it should be understood that the subject matter defined in the claims are unnecessarily limited to the specific features or actions described above. The specific features and actions described above are merely exemplary forms of implementing the claims.

Although multiple implementation details are included in the above descriptions, the details should not be interpreted as limitations to the scope of the present disclosure. Some features described in a context of an embodiment may be implemented in combination in another embodiment. Alternatively, some features described in a context of an embodiment may be implemented in multiple embodiments separately or in any suitable sub-combination.

The above description merely includes preferred embodiments of the present disclosure and explanations of the technical principles used. Those skilled in the art should understand that the scope of the present disclosure is not limited to the technical solution formed by a combination of the technical features described above, but also covers other technical solutions formed by any combination of the above technical features or the equivalent features of the technical features without departing from the concept of the present disclosure. For example, the scope of the present disclosure may cover a technical solution formed by replacing the features described above with technical features with similar functions disclosed in (but not limited to) the present disclosure.

1. A service monitoring method for a flight query system, comprising:
generating one or more query instructions based on preconfigured configuration information, wherein the configuration information indicates an airline, one or more pieces of identity information of the airline, and at least one popular city pair corresponding to each piece of the identity information, and each of the query instructions indicates a popular city pair corresponding to a piece of identity information of the airline;
generating a query message for each of the query instructions based on a preconfigured query message template;
sending the query message to the flight query system, simulating a piece of identity information of the airline to request the flight query system to query a popular city pair, and obtaining a query result from the flight query system; and
determining a blocking result of the flight query system on target identity information of a target airline based on a query result of a popular city pair queried by using the target identity information of the target airline.

2. The service monitoring method according to claim 1, wherein the generating one or more query instructions based on preconfigured configuration information comprises:
determining an airline indicated by the preconfigured configuration information;
acquiring one or more pieces of identity information of the airline; and
for each piece of identity information of the airline, determining a channel corresponding to the identity information and one or more popular city pairs corresponding to the identity information, and generating, for each of the popular city pairs, a query instruction based on the identity information of the airline, the channel corresponding to the identity information, and the popular city pair.

3. The service monitoring method according to claim 1, wherein the generating a query message for each of the query instructions based on a preconfigured query message template comprises:
determining a channel indicated by the query instruction;
querying a predetermined correspondence relationship between channels and query message templates to acquire a query message template corresponding to the determined channel; and
filling the airline, the identity information, the channel, and the popular city pair indicated by the query instruction at corresponding positions in the acquired query message template to generate the query message for the query instruction.

4. The service monitoring method according to claim 1, wherein the determining a blocking result of the flight query system on target identity information of a target airline based on a query result of a popular city pair queried by using the target identity information of the target airline comprises:
determining the popular city pair corresponding to the target identity information of the target airline;
acquiring the query result of the popular city pair queried by using the target identity information of the target airline;
determining whether the number of query result indicating a query failure in the acquired query result meets a predetermined blocking condition;
determining that the flight query system blocks the target identity information of the target airline in a case that the number of query result indicating a query failure in the acquired query result meets the predetermined blocking condition; and
determining that the flight query system does not block the target identity information of the target airline in a case that the number of query result indicating a query failure in the acquired query result does not meet the predetermined blocking condition.

5. The service monitoring method according to claim 4, further comprising determining whether a query result indicates a query failure, wherein the determining whether a query result indicates a query failure comprises:
acquiring a channel indicated by a query message corresponding to the query result;
querying a predetermined correspondence relationship between channels and blocking keywords to determine a target blocking keyword corresponding to the acquired channel;
determining whether the target blocking keyword exists in the query result;
determining that the query result indicates the query failure in a case that the target blocking keyword exists in the query result; and
determining that the query result indicates a query success in a case that the target blocking keyword does not exist in the query result.

6. The service monitoring method according to claim 4, wherein the determining whether the number of query result indicating a query failure in the acquired query result meets a predetermined blocking condition comprises:
determining the first number of the popular city pair corresponding to the target identity information of the target airline;
calculating the second number of the query result indicating the query failure in the acquired query result;
determining a proportion of the second number to the first number;
determining whether the proportion exceeds a predetermined target proportion;
determining the number of query result indicating the query failure in the acquired query result meets the predetermined blocking condition in a case that the proportion exceeds the target proportion; and
determining the number of query result indicating the query failure in the acquired query result does not meet the predetermined blocking condition in a case that the proportion does not exceed the target proportion.

7. A service monitoring apparatus for a fight query system, comprising:
a query instruction generation unit, configured to generate one or more query instructions based on preconfigured configuration information, wherein the configuration information indicates an airline, one or more pieces of identity information of the airline, and at least one popular city pair corresponding to each piece of the identity information, and the query instruction indicates a popular city pair corresponding to a piece of identity information of the airline;
a query message generation unit, configured to generate a query message for each of the query instructions based on a preconfigured query message template;
a simulation query unit, configured to send the query message to the flight query system, simulate a piece of identity information of the airline to request the flight query system to query a popular city pair, and obtain a query result from the flight query system; and
a blocking result determination unit, configured to determine a blocking result of the flight query system on target identity information of a target airline based on a query result of a popular city pair queried by using the target identity information of the target airline.

8. The service monitoring apparatus according to claim 7, wherein the query instruction generation unit comprises:
an airline determination unit, configured to determine an airline indicated by the preconfigured configuration information;
an identity information acquisition unit, configured to acquire one or more pieces of identity information of the airline; and
a query instruction generation subunit, configured to: for each piece of identity information of the airline, determine a channel corresponding to the identity information and one or more popular city pairs corresponding to the identity information, and generate, for each of the popular city pairs, a query instruction based on the identity information of the airline, the channel corresponding to the identity information, and the popular city pair.

9. A computer device, comprising:
a processor; and
a memory; wherein
the processor and the memory are connected through a communication bus, the processor is configured to call and execute a program stored in the memory, and the memory stores the program which is executed to perform the service monitoring method for a flight query system according to claim 1.

10. A computer-readable storage medium storing a computer executable instruction, wherein the computer executable instruction is executed to perform the service monitoring method for a flight query system according to claim 1.
